(19) United States
(12) Patent Application Publication
(10) Pub. No.: US 2010/0260083 A1
(43) Pub. Date: Oct. 14, 2010

(54) Method for Enhancing Accuracy of Rate Adaptation

(76) Inventors: Yen-Chin Liao, Taipei City (TW); Yung-Szu Tu, Taipei County (TW); Chun-Hsien Wen, Hsinchu County (TW); Jiunn-Tsair Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/420,824

(22) Filed: Apr. 9, 2009

(51) Int. Cl. H04B 7/00

(52) U.S. Cl. 370/310

(57) ABSTRACT

The present invention provides a method for enhancing accuracy of rate adaptation in a transmitter of a wireless communication system, which comprises setting a plurality of scores indicating reliabilities of a plurality of MCSs of the wireless communication system during rate adaption procedures of the plurality of MCSs, and adjusting the plurality of scores according to a plurality of response messages indicating receiving statuses of a plurality of transmitted packets.

### BACKGROUND OF THE INVENTION

1. Field of the Invention

The present invention relates to a method for enhancing accuracy of rate adaptation in a transmitter of a wireless communication system, and particularly, to a method for examining the reliabilities of MCSs during rate adaption procedures, to enhance the efficiency of rate adaptation.

2. Description of the Prior Art

Modulation and Coding Scheme, MCS, is used within a wireless communication system to specify the different modulation and coding parameters being applied. Different MCSs are classified by indexes; for example, in a system complying with IEEE 802.11n standard, MCS-15 represents the corresponding transmission applies 64-QAM, 5/6 coding rate, and two possible transmission rates based on bandwidth of 20 MHz or 40 Hz. To enhance transmission efficiency, the system should select an adequate MCS.

In the wireless communication system, a transmission channel is never ideal, and is affected by many factors, such as multi-path effect, fading effect, noise, or interference from other electronic systems. When the transmission environment of the transmission channel is changed, the system must reselect another adequate MCS, to prevent waste of radio resource if the channel can afford a transmission rate higher than the initial rate, or prevent descending throughput if the transmission environment deteriorates.

Since a transmitter of the wireless communication system cannot get information about the channel status, the transmitter can only check the transmission results, i.e. ACK (Acknowledgement) and NACK (Negative acknowledgement), to determine the variation of the transmission environment. In such a situation, the prior art has provided different algorithms, to determine channel status and perform rate adaptation, including Auto Rate Fallback (ARF), Adaptive ARF (AARF), Sample Rate (SR), Onoe, Adaptive Multi Rate Retry (AMRR), Multiband Atheros Driver for WiFi (Madwifi), and Robust Rate Adaptation Algorithm (RRAA) for example. Both ARF and AARF send probe packets, and determine to in-/decrease transmission rate according to detecting results. SR periodically sends probe packets with a transmission rate selected randomly, and determines a transmission rate having the highest throughput for the following transmissions. Onoe transmits packets with a specified transmission rate for a period, and increases transmission rate to the next level if a packet error rate during the period is lower than 10%, or otherwise, decreases the transmission rate. Both AMRR and Madwifi send probe packets, and determine to in-/decrease transmission rate according to receiving status of two consecutive packets. RRAA determines transmission rate according to ACK and receiving status of packets.

Therefore, the prior art rate adaptation methods need to send probe packets or compute transmission quality of a certain period, to update transmission rate. However, if a wireless communication system supporting real-time services applies the above-mentioned methods, low throughput occurs because MCS cannot converge in short time.

The prior art has disclosed another rate adaptation method, a probabilistic rate adaptation approach, by which a probability of SNR (Signal-to-noise Ratio) is updated based on transmission results (i.e. ACK), and MCS can be determined accordingly. In detail, the transmitter updates a conditional probability density function (CPDF) of SNR, so-called SNR soft information, of a current packet according to ACK related to another transmitted packet and SNR soft information of a former packet. Then, the transmitter selects an adequate MCS according to the updated SNR soft information, so as to transmit the next packet with better transmission rate.

Except performing rate adaptation algorithms, the transmitter can determine MCS according to MCS suggestion from the receiver, namely MCS feedback (MFB). With the aid of MFB from the receiver, rate adaptation performed by the transmitter can converge in short time. However, when the receiver suggests improper MCS, the inaccurate MFB can cause the rate adaptation algorithm converging to an inadequate MCS. Thus, longer adaptation time is needed to mend this mismatched MFB.

### SUMMARY OF THE INVENTION

It is therefore a primary objective of the claimed invention to provide a method for enhancing accuracy of rate adaptation in a transmitter of a wireless communication system.

The present invention discloses a method for enhancing accuracy of rate adaptation in a transmitter of a wireless communication system, which comprises setting a plurality of scores indicating reliabilities of a plurality of MCSs of the wireless communication system during rate adaption procedures of the plurality of MCSs, and adjusting the plurality of scores according to a plurality of response messages indicating receiving statuses of a plurality of transmitted packets.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process in accordance with an embodiment of the present invention.

FIG. 2 illustrates a schematic diagram of an ideal SNR-MCS zone in a 2T2R (two transmitter and two receiver) WiFi system.

FIG. 3 and FIG. 4 show an example to recover MFB offset in the prior art where MFB is derived from [5 dB, 5dB] SNR offset.

FIG. 5 show an example to recover MFB offset in the present invention where MFB is derived from [5 dB, 5 dB] SNR offset.

FIG. 6 shows a schematic diagram of a restarted rate adaptation number according to the present invention.

### DETAILED DESCRIPTION

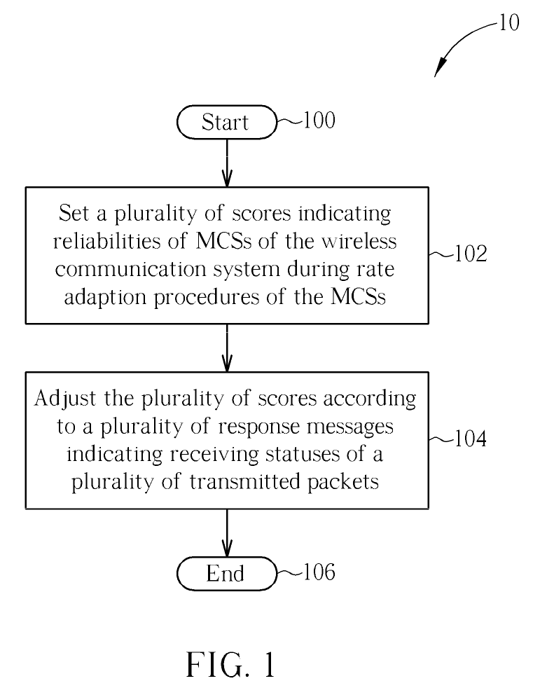

Please refer to FIG. 1, which is a flowchart of a process 10 in accordance with an embodiment of the present invention. The process 10 can enhance accuracy of rate adaptation in a transmitter of a wireless communication system, e.g. IEEE 802.11n, and comprises the following steps:

Step 100: Start.

Step 102: Set a plurality of scores indicating reliabilities of MCSs of the wireless communication system during rate adaption procedures of the MCSs.

Step 104: Adjust the plurality of scores according to a plurality of response messages indicating receiving statuses of a plurality of transmitted packets.

Step 106: End.

According to the process 10, the present invention sets a plurality of scores corresponding to different MCSs at first to indicate reliabilities of the MCSs, and adjusts each of the scores according to response messages, i.e. ACK and NACK. Therefore, each time an ACK corresponding to a packet transmitted with a specified MCS is received, the transmitter updates a score corresponding to the MCS, to evaluate the reliability of the MCS during rate adaptation. In such a situation, the scores represent “goodness” of the MCSs, by which the transmitter can determine whether to modify MFB-related parameters or select another MCS for rate adaptation.

Note that, the scores are set up initially, and changed dynamically as corresponding ACKs or NACKs are received, e.g. plus or minus 1. Thus, it is much easier to update the scores than to calculate SNR soft information with conditional probability density function.

For example, if mcsSet={0, 1, . . . , M−1} represents indexes of the available MCSs, then the present invention sets an M-typle vector mcsScore corresponding to mcsSet={0, 1, . . . , (M−1}, to indicate the reliabilities of the MCSs during rate adaption procedures. Each time an MCS=m is selected by the rate adaptation algorithm, the corresponding mcsScore(m) is modified by a logistic description:

```
If ACK = 1
    mcsScore(m) = mcsScore(m) +1;
Else
    mcsScore(m) = mcsScore(m) − 1;
End
```

Then, according to the updated mcsScore, the present invention can determine operations of rate adaption procedures. For example, a negative mcsScore can imply that:
1. There may be offset in the MFB if the receiver suggests MCS. In this way, modification of MFB is needed, whether to reduce the MCS to lower rates or to lessen the influence of MFB.
2. The MCS selected by the rate adaptation algorithm may be inaccurate. There may be other, and better, MCS.
3. Another round of rate adaptation is needed. The MCS with negative mcsScore can be marked “less probable” or omitted.

Therefore, after transmitting N packets, at the end of the rate adaptation algorithm, the transmitter can examine whether a stable MCS can be used for subsequent transmission. That is, if mcsScore of a stable MCS is negative, meaning that more than half of the transmitted packets fail, the transmitter can determine to modify MFB-related parameters, iteration number N, or jump to or restart from the “more probable MCS” corresponding to a non-negative mcsScore, to improve the adaptation efficiency. The above-mentioned operations can be concluded by a logistic description:

```
If mcsScore(current_MCS) > 0
    Adaptation terminates;
Else
    If mcsScore(MFB) ≦ 0 || current_MCS = MFB
        Modify MFB-related parameters;
        Modify iteration number N;
        Reset mcsScore to all-zero;
        Reset variables of rate adaption procedure;
        Rate adaptation restarts;
    Else
        Rate adaptation proceeds;
    End
End
```

With the aid of mcsScore, the transmitter can examine whether a stable MCS provided by the rate adaptation algorithm is qualified as “stable” for subsequent transmissions. Thus, the transmitter can accurately detect inadequate MCS or biased MFB, so as to enhance adaptation efficiency.

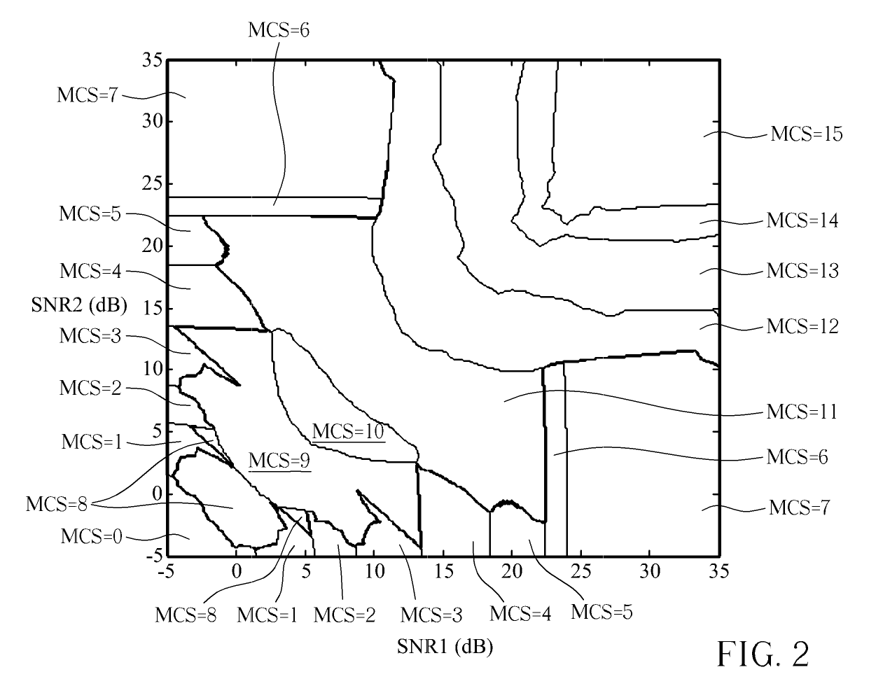

To show how the present invention improves adaptation efficiency, please refer to FIG. 2 to FIG. 6. FIG. 2 illustrates a schematic diagram of an ideal SNR-MCS zone in a 2T2R (two transmitter and two receiver) WiFi system. If p[m] represents conditional probability density function of SNR and Δ represents an MFB offset, then the rate adaptation algorithm can be as follows:

```
If ACK = 1
    p[m] = p[m] − 1, m < mcs_index
    p[m] = p[m] + 1, m ≧ mcs_index
Else
    p[m] = p[m] + 1, m < mcs_index
    p[m] = p[m] − 1, m ≧ mcs_index
End
p[mfb_index] = p[mfb_index] + Δ
```

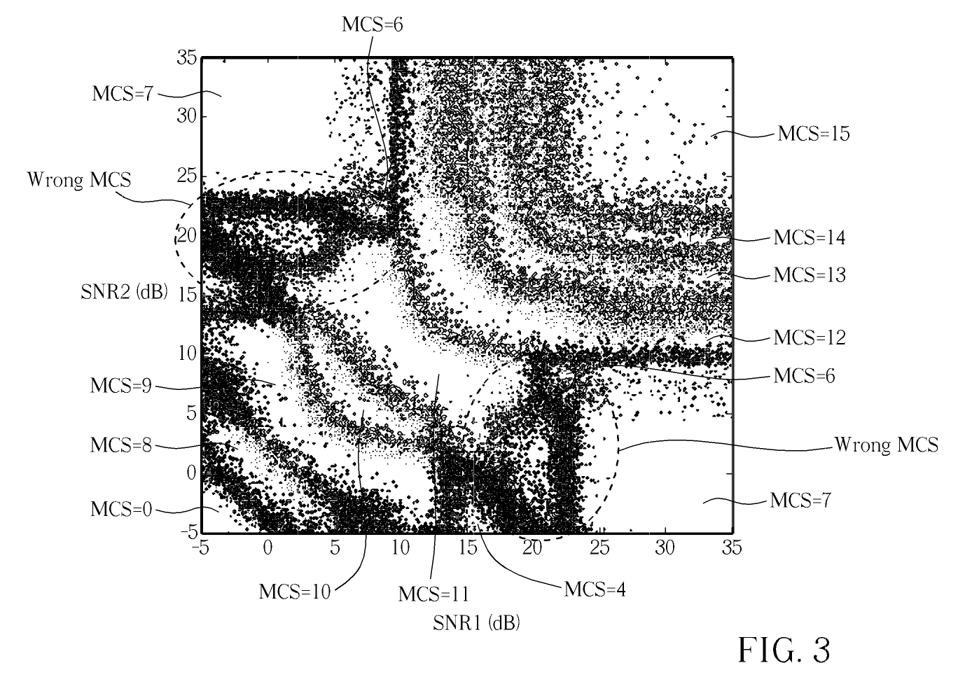

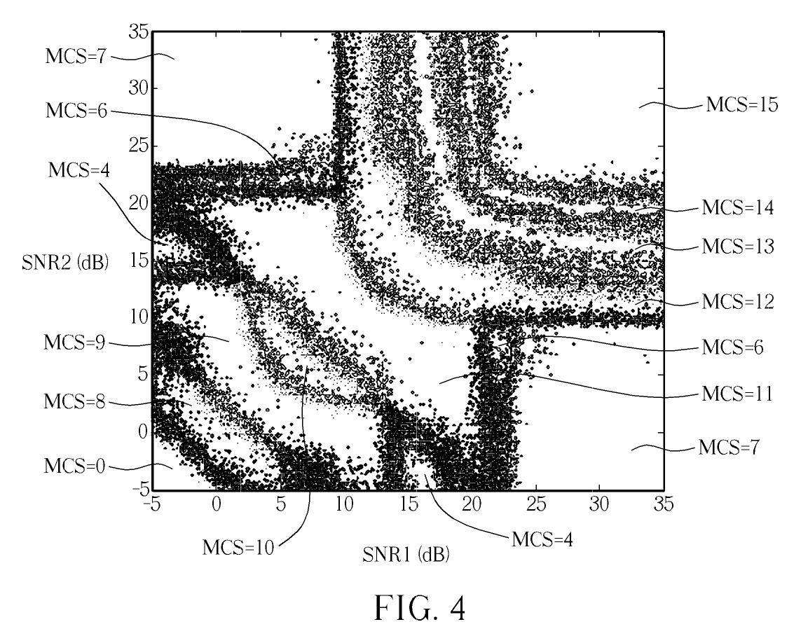

FIG. 3 and FIG. 4 show an example to recover MFB offset in the prior art where MFB is derived from [5 dB, 5 dB] SNR offset. In FIG. 3 and FIG. 4, black points represent wrong MCS. For example, in a region of MCS-15, the points are caused by MCS-0˜14. In FIG. 3, adaptation time=8 iteration, Δ=1, and wrong MCS may be chosen for some SNR values. In FIG. 4, adaptation time =16 iteration, Δ=1, most of the wrong MCSs are corrected.

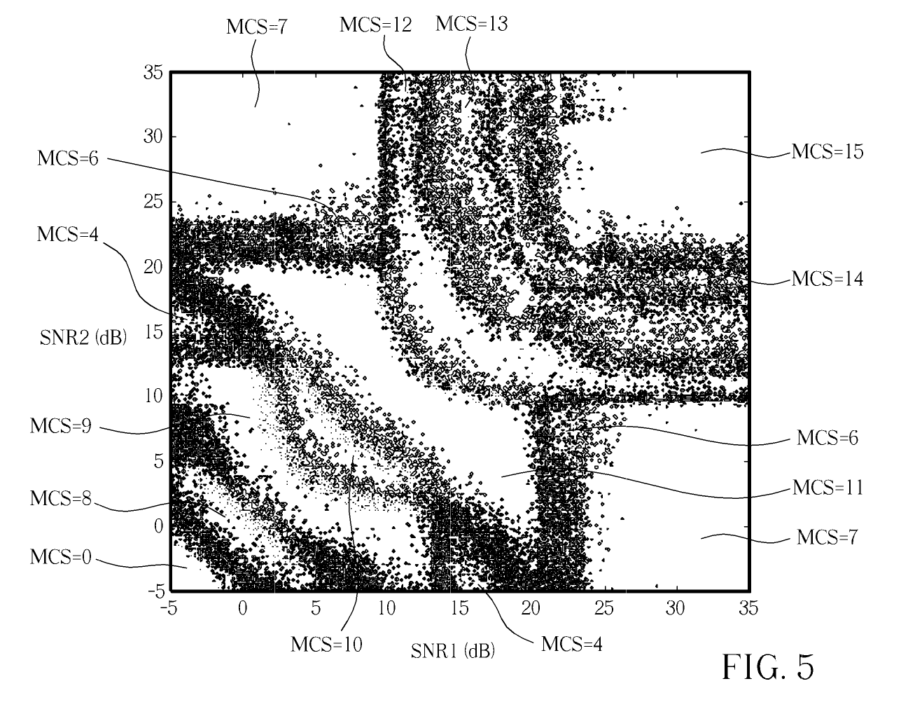

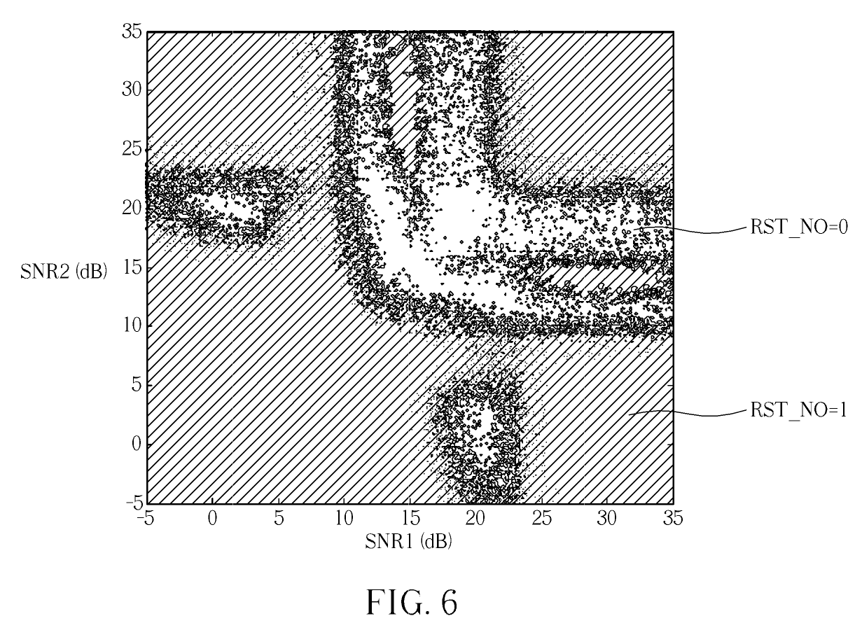

Under the same condition that MFB is derived from [5 dB, 5 dB] SNR offset, and the initial adaptation time is 8-iteration, via the present invention, the required iteration number is doubled and Δ is modified to Δ/2 when another round of rate adaptation is needed. The corresponding SNR-MCS zone is shown in FIG. 5, and a number of restarted rate adaptation RST_NO is shown in FIG. 6.

FIG. 5 and FIG. 6 show that at some SNR points, rate adaptation still converges within 8 iterations. That is, the present invention can detect inaccurate MFB and examine the convergence of rate adaptation. The parameters used in subsequent rate adaptation can be adjusted accordingly.

In the prior art, when the receiver suggests improper MCS, the inaccurate MFB can cause the rate adaptation algorithm converging to an inadequate MCS, and thus, longer adaptation time is needed. In comparison, the present invention sets mcsScore to indicate reliabilities of the MCSs, and the transmitter can determine whether to modify MFB-related parameters or select another MCS for rate adaptation accordingly.

In summary, the present invention can examine reliabilities of MCSs during rate adaption procedures, to enhance efficiency of rate adaptation.

Those skilled in the art will readily observe that numerous modifications and alterations of the device and method may be made while retaining the teachings of the invention.

What is claimed is:

1. A method for enhancing accuracy of rate adaptation comprising:
setting a plurality of scores indicating reliabilities of a plurality of modulation and coding schemes (MCSs) during rate adaption procedures of the plurality of MCSs; and
adjusting the plurality of scores according to a plurality of response messages indicating receiving statuses of a plurality of transmitted packets.

2. The method of claim 1, wherein the step of adjusting the plurality of scores according to the plurality of response messages indicating the receiving statuses of the plurality of transmitted packets comprises:
receiving a response message indicating a receiving status of a packet transmitted during a rate adaption procedure of an MCS; and
adding a value to a score corresponding to the MCS when the response message indicates that the packet is successively transmitted.

3. The method of claim 1, wherein the step of adjusting the plurality of scores according to the plurality of response messages indicating the receiving statuses of the plurality of transmitted packets comprises:
receiving a response message indicating a receiving status of a packet transmitted during a rate adaption procedure of an MCS; and
subtracting a value from a score corresponding to the MCS when the response message indicates that the packet is not successively transmitted.

4. The method of claim 1 further comprising determining operations of the plurality of rate adaption procedures according to the plurality of scores.

5. The method of claim 4, wherein the step of determining operations of the plurality of rate adaption procedures according to the plurality of scores is terminating a rate adaption procedure of an MCS and applying the MCS for subsequent transmissions when a score corresponding to the MCS represents that more than a predefined number of transmitted packets are successively transmitted.

6. The method of claim 5, wherein the predefined number is half of the plurality of packets.

7. The method of claim 4, wherein the step of determining operations of the plurality of rate adaption procedures according to the plurality of scores is changing from a first rate adaption procedure of a first MCS to a second rate adaption procedure or a second MCS when a first score corresponding to the first MCS represents that more than a predefined number of packets transmitted with the first MCS are not successively transmitted.

8. The method of claim 7 further comprising modifying parameters related to the plurality of rate adaption procedures when the first MCS is suggested by a receiver.

9. The method of claim 7, wherein a transmission rate corresponding to the second MCS is lower than that of the first MCS.

10. The method of claim 7, wherein the predefined number is half of the plurality of packets.
